(19) United States
(12) Patent Application Publication
(10) Pub. No.: US 2026/0260239 A1
(43) Pub. Date: Sep. 3, 2026

(54) FLEXIBLE CREDENTIAL ENABLED PUSH NOTIFICATIONS

(71) Applicant: Wells Fargo Bank, N.A., San Francisco, CA (US)

(72) Inventors: Prafullata Hari Diwate, Walnut Creek, CA (US); Hao Li, San Franisco, CA (US); Robin H. Lok, Piedmont, CA (US)

(21) Appl. No.: 19/067,127

(22) Filed: Feb. 28, 2025

(51) Int. Cl. G06Q 20/40; G06Q 30/0207

(52) U.S. Cl. CPC G06Q 20/401; G06Q 30/0222

(57) ABSTRACT

Systems and techniques for flexible credential enabled push notifications are described. A unified payment credential links multiple funding sources through encrypted communication channels. The system determines optimal processing paths between default and alternative paths while preserving transaction state through secure queuing without pre-authorization charges. A rules engine analyzes merchant categories and calculates rewards across funding sources in real-time. Transaction integrity is maintained during source switching through authenticated state transitions and parameter encryption. The system generates secure push notifications about alternative funding options, processes authenticated user responses and preserves transaction states during user interaction. Status updates are synchronized across digital interfaces through protected channels. The implementation enables secure transaction processing while maintaining optimization capabilities through sophisticated rules processing, real-time notifications, and protected state management.

### TECHNICAL FIELD

Embodiments described herein generally relate to electronic credentials and, in some embodiments, more specifically to transaction state preservation for credential element switching.

### BACKGROUND

Traditional payment systems require users to physically carry and manage multiple credit and debit cards to optimize rewards and benefits across different transaction categories. This creates unnecessary complexity and often results in missed opportunities to maximize card benefits, as users may not always carry or remember to use the optimal card for a given purchase. Additionally, existing systems typically process transactions using the presented payment method without providing users an opportunity to select alternative funding sources that might offer better rewards or terms.

While current fraud detection systems can pause transactions for security verification, there is no equivalent mechanism for optimizing payment source selection at the point of sale. Users are generally locked into their initial payment choice, even if better options exist. Furthermore, when users do have multiple payment options available through digital wallets, they often lack real-time information about which funding source would provide the best benefits for a specific transaction.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment and a system for flexible credential enabled push notifications, according to an embodiment.

FIG. 2 illustrates a flow diagram of an example transaction flow for flexible credential enabled push notifications, according to an embodiment.

FIG. 3 illustrates a flow diagram of an example of a transaction flow process for flexible credential enabled push notifications, according to an embodiment.

FIG. 4 is a block diagram of an example of a unified credential for flexible credential enabled push notifications, according to an embodiment.

FIG. 5 illustrates an example of a method for flexible credential enabled push notifications, according to an embodiment.

FIG. 6 is a block diagram illustrating an example of a machine upon which one or more embodiments may be implemented.

### DETAILED DESCRIPTION

Conventional payment systems implement rigid transaction processing paths that lock users into an initial payment source selection. These systems lack the technical capability to evaluate and modify funding sources in real-time, requiring users to either cancel and restart transactions or remain committed to potentially sub-optimal payment choices. Conventional payment systems lack sophisticated mechanisms for real-time evaluation of available rewards across multiple funding sources, category-specific benefits and promotions, transaction-specific optimization opportunities, and user-defined preferences and rules.

Conventional payment systems lack sophisticated notification frameworks that can alert users to better funding options, provide comparative benefit analysis, enable interactive source selection, and maintain transaction state during user interaction. Conventional payment systems lack the technical capability to process complex rule sets in real-time, evaluate multiple funding sources simultaneously, apply user preferences dynamically, and maintain consistent rule application across different transaction types.

Conventional payment infrastructures face technical challenges in maintaining transaction state while enabling funding source modifications typically requiring pre-authorization charges or holds against specific payment sources, creating unnecessary network traffic and potential holds on multiple funding sources when attempting to optimize payment selection. While existing fraud detection systems demonstrate the capability to pause transactions for security verification, conventional payment systems have not successfully integrated similar functionality for payment optimization. This technical limitation prevents real-time intervention for funding source optimization even when better options are available.

Conventional digital wallets, despite storing multiple payment credentials, lack the technical infrastructure to dynamically evaluate optimal funding sources, provide real-time feedback on source selection, enable post-transaction source modification, and maintain transaction integrity during source switching. Conventional payment systems have security architecture constraints that present technical challenges in maintaining transaction security during source switching, preserving transaction state during optimization, enabling secure post-transaction modifications, and implementing multi-source evaluation without compromising security.

These technical limitations create significant inefficiencies in payment processing and prevent users from optimizing their payment choices, necessitating a new technical approach to flexible payment credential management.

The systems and techniques described herein eliminate unnecessary pre-authorization charges and transaction holds using a unified credential and dual-path processing architecture. This provides immediate efficiency gains by reducing network traffic by avoiding redundant authorization requests, eliminating multiple holds on user accounts, and streamlining the transaction flow through unified credential processing. The unified credential is linked to multiple funding sources including credit and debit cards and enables management and configuration of default payment sources. The unified credential supports both physical cards and digital wallets. Advanced transaction state management is used that maintains transaction integrity without requiring pre-authorization charges, enables secure transaction queuing without network overhead, and supports modification windows without duplicate processing requirements. These features allow for source selection during processing of a transaction rather than requiring a fixed source to be provided at transaction initiation.

A rules engine delivers immediate optimization through real-time evaluation of transaction characteristics, simultaneous assessment of multiple funding sources, and dynamic application of user preferences without processing delays. A push notification system improves processing efficiency by leveraging existing fraud detection infrastructure, enabling source selection without transaction restart, and providing immediate feedback through visual and haptic mechanisms. A flexible credential architecture enables immediate access to multiple funding sources through a single credential, real-time reward optimization across all linked payment methods, and dynamic source switching without transaction cancellation

Continued optimization is enabled through specified modification windows for source changes, maintained transaction state during modification periods, and seamless processing updates without duplicate authorizations. Consistent optimization is maintained across physical card implementations, digital wallet interfaces, point of sale systems, and mobile payment platforms.

An improved security framework delivers maintained transaction integrity during source switching, secure state preservation during optimization, and enhanced protection through unified credential management. These technical improvements represent significant advancements over conventional payment systems by eliminating redundant processing steps, reducing network overhead, and enabling real-time optimization without compromising transaction security or user experience.

Sophisticated rules processing, real-time notifications, and secure transaction management are combined to provide an enhanced payment experience that maximizes customer benefits while maintaining transaction security and simplicity. This enables a customer to change payment sources mid-transaction while reducing network traffic and maintaining end-to-end security and privacy.

For example, a customer walks into a grocery store to make a purchase. Rather than carrying multiple credit and debit cards, the customer has a single unified payment credential linked to several funding sources-their rewards credit card that offers 5% cash back on groceries, another credit card with a current promotional offer, and their debit card.

When the customer reaches checkout and taps their phone to pay using their digital wallet, the system immediately begins processing the transaction. A rules engine identifies this as a grocery store purchase based on the merchant category code. It evaluates pre-configured rules for the customer, which include using cards that maximize rewards for grocery purchases.

The system quickly determines that while the default payment source of the customer would work, another credit card of the customer currently has a special promotional offer that would provide better rewards for this specific purchase. Rather than simply processing with the default, a push notification is sent to the phone of the customer.

The notification appears on the phone screen, showing: “Better reward option available! Use your Rewards Card to earn 5% back on this $120 grocery purchase instead of your default card's 1%. Tap to switch.” The interface provides clear options to either proceed with the default card or switch to the recommended card.

The customer taps the notification to switch to the better rewards card. A visual confirmation is immediately provided through the digital wallet interface, showing artwork of the selected card, and gives a subtle haptic feedback confirmation. The transaction then completes using the selected funding source.

The transaction state is maintained securely throughout this interaction without requiring any pre-authorization charges or holds on either funding source. The point-of-sale system of the merchant only sees a single unified credential, while the customer gets the benefit of optimized reward earnings.

After the transaction, preferences are updated for the customer. Because the customer chose to switch cards for this grocery purchase, the customer is offered an update to the default rules to automatically use this card for future grocery purchases. The customer can easily accept this suggestion through the digital wallet interface.

A modification window is maintained after the transaction completes. If the customer later discovers an even better promotion or reward opportunity on one of their other linked payment sources, the customer can switch the funding source within the specified timeframe without needing to cancel or reprocess the transaction.

Throughout this entire process, transaction security is maintained through encrypted communications, authenticated user interactions, and protected state management. The customer experiences a seamless payment process while automatically optimizing their rewards and benefits across all their available payment options.

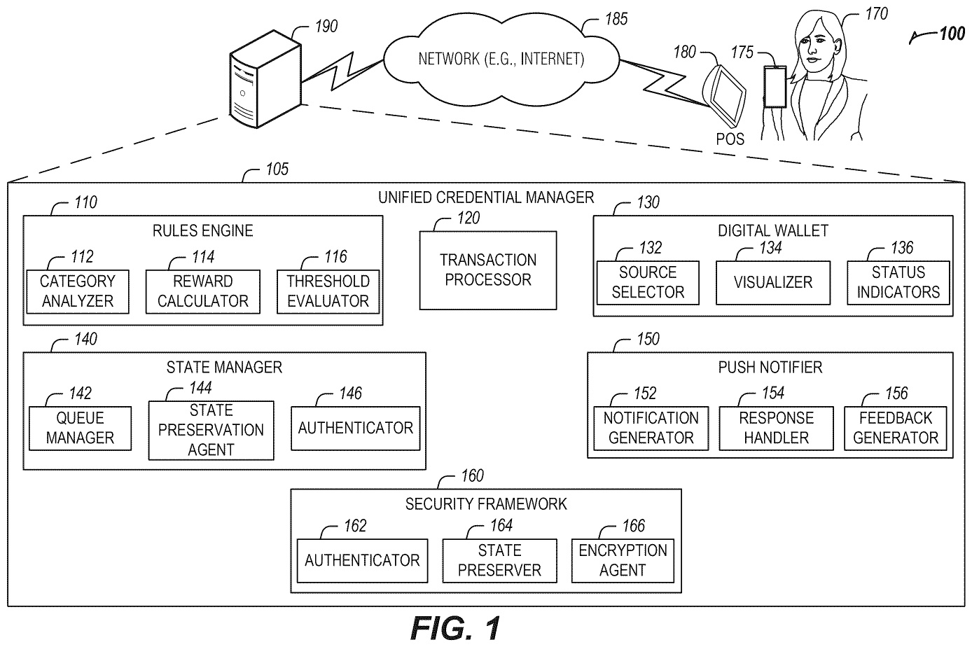

FIG. 1 is a block diagram of an example of an environment 100 and a system 105 for flexible credential enabled push notifications, according to an embodiment. The environment 100 includes a customer 170 (e.g., a user, etc.) that is using a mobile device 175 (e.g., a smartphone, a tablet, a notebook computer, a fob, a smart credit card, etc.) to complete a transaction via a point-of-sale (POS) system 180 that is communicatively coupled to an electronic payment platform 190 (e.g., a payment computing network, a computing infrastructure of a financial institution, a cloud-based computing platform, etc.) via a network 185 (e.g., the internet, a wide area network, a wireless network, a local area network, etc.). The electronic payment platform 190 may include the system 105. In an example, the system 105 is a unified credential manager.

The system 105 implements a variety of components that link multiple funding sources to a single payment credential while maintaining secure connections across platforms. The system 105 includes a rules engine 110, a transaction processor 120, a digital wallet 130, a state manager 140, a push notifier 150, and a security framework 160.

Seamless integration with both physical card and digital wallet implementations is enabled through protected credential state management. Credential linking maintains continuous authentication protocols while enabling dynamic source modifications. State management preserves credential integrity during transactions and modifications. Platform integration ensures consistent functionality across physical and digital implementations while maintaining security protocols.

The rules engine 110 processes transaction characteristics through multiple specialized components that work in concert to optimize funding source selection. The rules engine 110 includes a category analyzer 112, a rewards calculator 114, and a threshold evaluator 116.

The category analyzer 112 performs real-time merchant category identification through sophisticated pattern matching algorithms and processes transaction characteristics to determine applicable category-specific rules and preferences. The category analyzer 112 evaluates transaction parameters against stored category configurations, applies user-defined category rules in real-time, and maintains secure state preservation during all evaluation processes.

The rewards calculator 114 implements comprehensive analysis of available rewards across all linked funding sources and maintains real-time data on category-specific reward rates and promotional offers. The rewards calculator 114 evaluates potential benefits across different funding sources simultaneously, uses an optimization algorithm to determine maximum reward opportunities for each transaction, and identifies situations where user alerts should be transmitted regarding better reward options.

The threshold evaluator 116 processes complex routing rules based on transaction amounts and user-defined parameters and compares transaction values against configured thresholds. The threshold evaluator 116 applies threshold-based rules to select optimal processing paths, processes exception conditions and special promotions, and coordinates with the category analyzer 112 and the rewards calculator 114 to maintain consistent rule application.

The rules engine 110 enables real-time evaluation of funding sources. When a transaction is initiated, transaction parameters are transmitted to the rules engine 110 for processing through the category analyzer 112 and rewards calculator 114. The transaction processor 120 receives evaluation results from the rules engine 110 to determine an optimal processing path. The evaluation results include reward calculations for source comparison, threshold evaluation results for routing decisions. The transaction processor maintains state information during processing.

The rules engine 110 enables users to establish multiple types of baseline rules for funding source selection. Users can configure default payment sources for different transaction categories, such as designating specific credit cards for grocery purchases or gas station transactions. The rules engine 110 supports threshold-based rules, such as automatically selecting debit cards for transactions below specified dollar amounts.

When a transaction is initiated, the rules engine 110 initiates the category analyzer 112 to identify a merchant category, determine applicable category-specific rules, and evaluate any threshold conditions in conjunction with the threshold evaluator 116. The reward calculator is initiated to analyze potential benefits across linked funding sources by calculating available rewards for each funding source, identifying any active promotional offers, comparing reward rates across different cards, and evaluating category-specific bonus rewards.

The rules engine 110 implements a multi-factor optimization process that evaluates the default source by checking pre-configured rules for the transaction category, validating default source availability, and confirming sufficient funds/credit. Alternate sources are evaluated by identifying potentially better funding sources, calculating comparative benefits, and determining if alternative source notification is warranted.

A variety of rules of varying types may be defined. For example, category-based rules can include merchant category specific rules (e.g., grocery, gas station purchases, etc.), default source assignments per category, category-specific reward optimization parameters, etc. For example, threshold rules can include transaction amount-based routing, minimum/maximum amount triggers, default source override conditions, etc. For example, reward optimization rules can include category-specific reward calculations, promotional offer integration, comparative benefit analysis, etc.

Table 1 contains an example of a category-based rule.

TABLE 1

IF transaction\_category = “grocery” THEN
evaluate\_reward\_rates( )
compare\_against\_default( )
trigger\_notification\_if\_better\_option( )

In a category-based optimization example, when the customer 170 makes a grocery purchase, the category analyzer 112 identifies a merchant as being in a grocery category, the rewards calculator 114 evaluates reward rates across linked cards, the rules engine 110 applies any user-defined grocery category preferences and determines if a default grocery card provides optimal rewards.

Table 2 contains an example of a threshold rule.

TABLE 2

IF transaction\_amount < threshold\_value THEN
route\_to_debit\_processing( )
ELSE
evaluate\_credit\_options( )

In a threshold-based processing example, for small transactions the threshold evaluator 116 compares a transaction amount against threshold rules, evaluates if the transaction qualifies for debit card routing, and checks for any override conditions or special promotions in conjunction with the rewards calculator 114.

The rules engine 110 implements intelligent notification triggers that compare a selected and an optimal source, evaluate if better funding options exist, calculates potential benefit differential, and determines notification urgency. Contextual alerts are generated that provides specific benefit comparisons, include reward calculations, and present clear alternative options.

The system 105 maintains evaluation capabilities by the rules engine 110 within a specified timeframe after transaction completion by continuing to monitor for better funding options, enabling source modification if better options are identified, and maintaining transaction state during the modification window.

The rules engine 110 integrates with the transaction processor 120, the push notifier 150, the digital wallet 130, the security framework 160, and with profile systems that contain user preferences. The rules engine 110 enables real-time evaluation of funding sources. When a transaction is initiated, transaction parameters are transmitted to the rules engine 110 for processing through the category analyzer 112 and rewards calculator 114.

The transaction processor 120 receives evaluation results from the rules engine 110 to determine an optimal processing path. The evaluation results include reward calculations for source comparison, threshold evaluation results for routing decisions.

The transaction processor 120 maintains state information during processing. The transaction processor 120 implements dual processing paths that enable both immediate default source processing and dynamic source selection capabilities. The transaction processor 120 implements immediate transaction handling using preconfigured rules and preferences and processes transactions according to stored default configurations. The transaction processor 120 maintains transaction integrity during processing by implementing continuous authentication throughout the transaction lifecycle. The transaction processor 120 provides real-time processing status updates. The transaction processor 120 works in conjunction with other components of the system 105 to implements error handling for default processing through transaction state preservation during failures, secure queue management for interrupted transactions, authentication protocol maintenance during recovery, and protected parameter preservation during retries.

If an alternate payment source is identified that will provide more benefits to the customer 170, the transaction processor 120 enables dynamic funding source selection through sophisticated state management and maintains secure transaction states during selection processes. The transaction processor 120 coordinates with the push notifier 150 for customer 170 interactions. The transaction processor 120 enables secure modifications to funding sources and maintains transaction integrity during all modifications. For source switching failures, transaction processor 120 works in conjunction with other components of the system 105 to maintain original transaction parameters, preserve default source availability, enable secure transaction recovery, and implement protected state transitions. For switch recovery, the system 105 enables secure transaction resumption, maintains original transaction parameters, implements protected state recovery, and preserves funding source availability.

In the event of an incomplete source switch the system 105 recovers by initiating protected transaction state maintenance, securely falling back to default sources, maintaining parameter preservation, and preserving authentication protocols.

The transaction processor 120 coordinates with multiple components. The transaction processor 120 works in conjunction with the push notifier 150 to trigger notifications for better funding options, process user responses for source selection, and provide transaction status updates. The transaction processor 120 works in conjunction with the state manager 140 to maintain transaction queues during processing, preserve transaction states during modifications, and implement authentication protocols.

The digital wallet 130 provides real-time visual feedback and interaction capabilities through multiple specialized components. The digital wallet 130 includes a source selector 132, a visualizer 134, and status indicators 136. The source selector 132 enables secure funding source management while maintaining consistent interface presentation across platforms. The visualizer 134 implements multiple feedback types including transaction status updates and processing confirmations. The status indicators 136 provide real-time transaction state information through protected channels. The digital wallet 130 maintains secure communication with other components of the system 105 while enabling protected user interactions. The digital wallet 103 includes recovery mechanisms including secure interface recovery mechanisms, protected state synchronization, maintained transaction integrity, and real-time status updates.

The digital wallet 130 receives updates from the transaction processor 120, displays notifications from the push notifier 150, implements visual feedback through the visualizer 134, and maintains the status indicators 136 based on updates from the state manager 140.

The state manager 140 implements comprehensive transaction state preservation through secure queuing mechanisms and authentication protocols. The state manager includes a queue manager 142, a state preservation agent 144, and an authenticator 146.

The queue manager 142 implements secure transaction state preservation without requiring pre-authorization charges and maintains transaction order and priority. The queue manager 142 protects transaction parameters during processing, enables secure transaction updates, and maintains consistent states across all components.

The state preservation agent 144 maintains protected transaction states during processing phases and secures transaction details during modifications. The state preservation agent 144 enables secure processing path changes, handles interrupted transactions, and ensures state integrity throughout processing.

The authenticator 146 implements continuous security verification during system operations and processes user authentication requests. The authenticator 146 confirms processing integrity, manages secure source changes, and maintains consistent authentication across components.

The system 105 implements a sophisticated state manager 140 that maintains transaction integrity without requiring pre-authorization charges. The state manager 140 enables secure transaction queuing and state preservation throughout the source selection and modification process.

The state manager 140 implements secure transaction queuing mechanisms, maintains transaction parameters during source selection, preserves state without creating holds on funding sources, and enables modification windows without duplicate processing. State transitions are managed through protected transaction parameter preservation, secure authentication protocols, maintaining integrity during modifications, and providing real-time state updates across platforms.

During pre-switch state management original transaction parameters are maintained, secure transaction queuing is implemented, funding source availability is preserved, and user interaction authentication is enabled. During source switching, the state manager 140, maintains transaction integrity, processes secure state transitions, implements authentication protocols, and ensures continuous state preservation. The state manager 140 supports specified modification timeframes, maintained transaction state during modifications, secure processing updates, and protected parameter preservation. State synchronization is enabled by the state manager 140 using cross-platform state synchronization, real-time interface updates, secure communication channels, and protected state transitions.

The authenticator 146 of the state manager 140 employs multi-layer authentication protocols, secure state access controls, protected modification processes, and transaction validation mechanisms. The state manager 140 ensures continuous transaction integrity, protected state preservation, secure parameter management, and authenticated state transitions.

The state manager 140 coordinates across components to maintain transaction integrity during processing, enable secure source switching between paths using the state preservation agent 144, preserve authentication states during modifications using the authenticator 146, and coordinate queue management across processing paths using the queue manager 142.

The push notifier 150 generates and delivers context-specific alerts about alternative funding options through secure communication channels. The push notifier 150 includes a notification generator 152, a response handler 154, and a feedback generator 156.

The notification generator 152 creates context-specific alerts about alternative funding options through secure channels and produces targeted messages based on transaction analysis. The notification generator 152 coordinates notification delivery for optimal user interaction, determines appropriate notification types for different scenarios, and ensures successful notification transmission.

The response handler 154 processes authenticated user interactions while maintaining transaction security. The response handler 154 verifies user responses for processing integrity and confirms user identity for modifications. The response handler 154 maintains transaction integrity during response processing and provides real-time feedback for user actions.

The feedback generator 156 implements multiple confirmation mechanisms across digital interfaces and provides real-time status updates through an interface that may include haptic generation producing tactile confirmations for user actions and graphic generation for producing visual feedback. The feedback generator 156 coordinates feedback across multiple channels and maintains consistent feedback states.

The push notifier 150 parallels existing fraud detection mechanisms while extending functionality for payment optimization. The push notifier 150 leverages established notification infrastructure to enable real-time funding source optimization during transaction processing. The push notifier 150 initiates notifications based on real-time evaluation of transaction characteristics, comparison of default versus optimal funding sources, identification of enhanced reward opportunities, and detection of promotional offers or special conditions.

Notifications are generated in conjunction with the rules engine 110 through evaluation of predefined category rules, assessment of threshold conditions, analysis of user-defined preferences, and comparison against reward optimization parameters.

The push notifier 150 provides real-time notification creation, context-specific message formatting, interactive option presentation, and visual and haptic feedback integration. Notifications are delivered through the digital wallet 130, mobile device notifications, secure communication channels, and cross-platform synchronization.

The push notifier 150 processes responses from the customer 170 through secure authentication protocols, real-time source selection confirmation, transaction state preservation, and modification window management. Upon receipt of a response from the customer 170, the push notifier 150 updates funding source selection, maintains transaction integrity, processes necessary authorizations, and confirms successful modifications in conjunction with the other components of the system 105.

The push notifier 150 enables immediate notification delivery, source selection before processing, real-time optimization opportunities, and default source override options. The push notifier 150 supports time-window based modifications, alternative source suggestions, reward optimization alerts, and confirmation notifications.

The push notifier 150 maintains secure communication channels, protected user authentication, transaction state integrity, and encrypted data transmission. If a notification times out the error is corrected by maintaining transaction state during notification delays, implementing secure default processing fallbacks, preserving source selection options, and enabling recovery through the digital wallet 130.

The push notifier 150 interfaces with the transaction processor 120 for status updates, the digital wallet 130 for user interaction, the state manager 140 for transaction preservation, and the security framework 160 for authenticated communications.

The security framework 160 implements comprehensive protection across system components through multiple specialized security mechanisms. The security framework 160 includes an authenticator 162, a state preserver 164, and an encryption agent 166.

The authenticator 162 implements multi-layer security verification across system operations and processes user authentication requests. The authenticator 162 confirms processing integrity, manages secure source changes, and maintains consistent authentication states. The state preserver 164 maintains secure transaction states throughout processing phases and secures transaction details during modifications. The state preserver 164 enables secure processing path changes, handles interrupted transactions, and ensures state integrity throughout processing. The encryption agent 166 implements secure data transmission across system components and maintains secure communication channels. The encryption agent 166 coordinates encryption protocols, ensures secure data delivery, and tracks communication integrity.

The security framework 160 implements a sophisticated system that parallels existing fraud detection mechanisms while extending capabilities for secure source optimization. The security framework 160 maintains transaction integrity through secure communication channels and state preservation mechanisms during the transaction lifecycle.

The security framework 160 enables transaction state preservation by the state preserver 164 through pre-authorization management that maintains transaction state without requiring pre-authorization charges, implements secure transaction queuing mechanisms, preserves transaction details while awaiting user input, and ensures funding source availability without creating holds. Source switching security is implemented by maintaining transaction integrity during modification windows, preserving original transaction parameters, enabling secure communication during user interaction, and implementing authentication protocols for source changes.

Modification window protection is used to securely manage post-transaction modifications by maintaining transaction state within specified timeframes, implementing secure authentication for modification requests, preserving original transaction parameters, and ensuring secure processing of source changes. The security framework 160 provides secure queuing that maintains transaction integrity without network overhead, enables secure state preservation during processing, implements authentication protocols for queue management, and ensures secure communication during state changes. In the event a modification window times out the components of the system 105 maintain transaction integrity throughout timeout periods, implement secure state preservation, enable protected recovery mechanisms, and preserve authentication protocols.

The security framework 160 maintains security across implementations through secure credential management in digital environments, protected source selection interfaces, authenticated modification processes, and encrypted communication channels.

For card-present transactions, the security framework 160 maintains secure communication channels, implements protected state management, ensures authenticated source selection, and preserves transaction integrity across platforms.

The security framework 160 implements multi-layer authentication for source selection modifications, post-transaction changes, rule configuration updates, and transaction state access. Security protocols ensure valid funding source availability, authenticated user interactions, protected transaction parameters, and secure state transitions.

The security framework 160 provides cross-component protection through authentication protocol implementation by the authenticator 162 across components of the system 105, secure state preservation using the state preserver 164 during component interactions, encrypted communication channel maintenance by the encryption agent 166, and protected data transmission between components.

The system 105 implements comprehensive monitoring including transaction metrics tracking through transaction processing path analysis, source switching success rates, notification delivery tracking, and rule evaluation performance metrics. Performance monitoring tracks transaction state preservation efficiency, queue management performance, authentication protocol response times, and cross-platform synchronization metrics. Error rate analysis in enabled using processing path monitoring to track error rates by evaluating default source processing failures, alternative source switching issues, push notification delivery failures, and transaction state preservation errors. Recovery metrics are used for recovery performance monitoring that include transaction recovery success rates, timeout scenario frequency, authentication failure analysis, and state preservation effectiveness.

System performance analytics include response time monitoring that tracks rule evaluation processing times, push notification delivery latency, source switching completion rates, and transaction queue management efficiency. Cross-platform performance is analyzed using digital wallet integration metrics, physical card processing performance, interface response times, and state synchronization effectiveness.

Reporting is provided for real-time monitoring including transaction success rate dashboards, error rate visualization, performance metric tracking, and system health indicators. Historical analysis reporting is used to enable trend analysis across processing paths, error pattern identification, performance optimization opportunities, and system improvement recommendations.

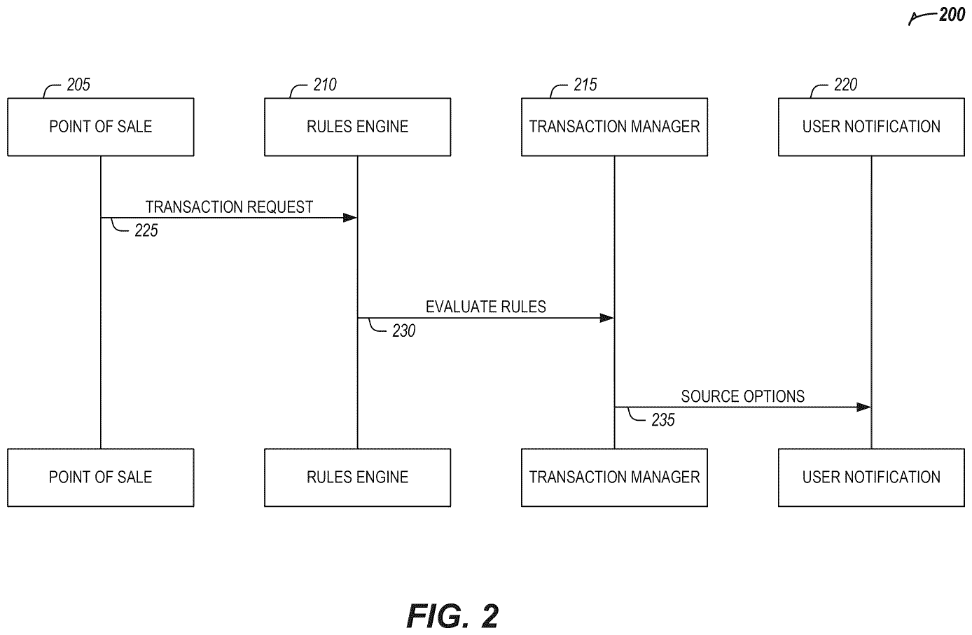

FIG. 2 illustrates a flow diagram of an example transaction flow 200 for flexible credential enabled push notifications, according to an embodiment. The transaction flow 200 may provide features as described in FIG. 1.

At point of sale 205, a customer makes a payment transaction request 225 that is transmitted to a rules engine 210 (e.g., the rules engine 110 as described in FIG. 1, etc.). Two distinct processing paths are provided for transaction handling. (1) A default processing path that utilizes preconfigured rules for immediate transaction processing, processes transactions using default funding sources based on category rules and maintains transaction integrity without requiring pre-authorization holds. (2) An alternative source path that enables dynamic source selection through push notifications, maintains transaction state during selection process, and implements secure queuing without requiring initial charges.

The rules engine 210 evaluates transaction characteristics and optimal routing is determined based on merchant category identification, rule evaluation for default sources, available reward calculations, and promotional offer assessment. The default path may be chosen based on default path criteria, predefined category rule matches, default source availability confirmation, and transaction parameter validation. An alternative path may be chosen when the rules engine 210 identifies better funding options, calculates reward differentials, and determines notification necessity. The rules evaluation is transmitted at 230 to the transaction manager 215 (e.g., the transaction processor 120 as described in FIG. 1, etc.) from the rules engine 210. The transaction manager 215 maintains transaction integrity through queue management that secures transaction state preservation, maintains integrity during source selection, and protects modification windows; processing controls that provide transaction parameter preservation, secure state transitions, and authentication protocol implementation.

Cross-platform integration is enabled through digital wallet processing including real-time interface updates, visual confirmation mechanisms, and secure source selection interfaces. The transaction manager 215 transmits the source options 235 in a user notification 220. The user notification may be in a financial application, digital wallet, or other secure user interface mechanism.

If the customer uses a physical card, default source processing will be completed with push notification integration if the customer has the physical card associated with a unified credential that provided alternative source selection capability. For example, the customer uses a physical credit card (e.g., swipe, tap, manual entry, etc.) at the point-of-sale to pay for an item. The rules engine may be initiated if it is determined that the physical credit card is configured in a unified credential by a payment processing network. The user notification 220 with available alternative sources may be transmitted to a secure application on a device of the user to allow the user to change funding sources while the transaction is in progress.

The dual path architecture enables efficient transaction processing while maintaining security and providing optimization opportunities through intelligent source selection and modification capabilities.

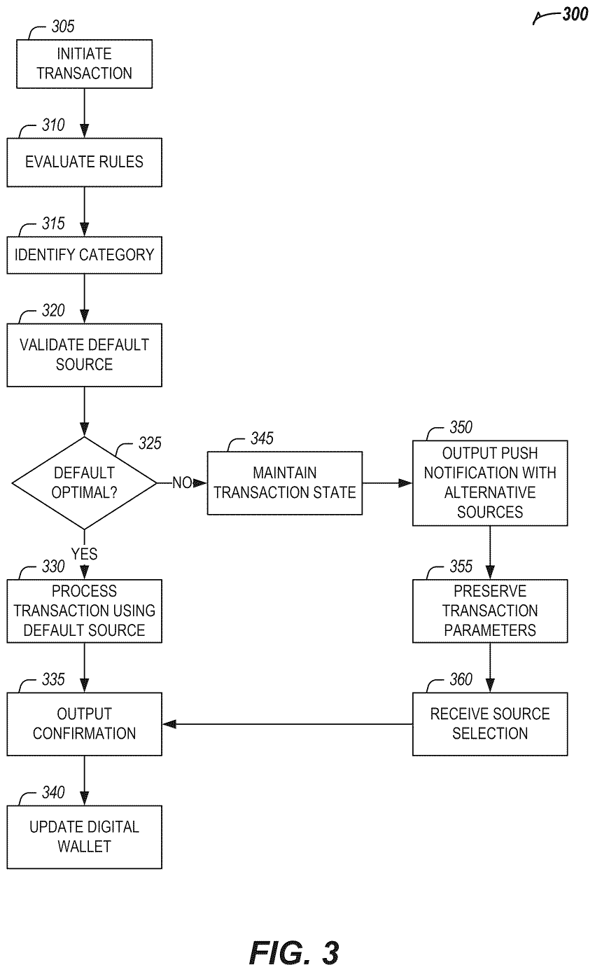

FIG. 3 illustrates a flow diagram of an example of a transaction flow process 300 for flexible credential enabled push notifications, according to an embodiment. The transaction flow process 300 may provide features as described in FIGS. 1 & 2.

At operation 305, a transaction is initiated when a customer presents a unified payment credential at a point-of-sale terminal. A transaction request is received, and processing is initiated while transaction parameters are securely preserved by a queue manager. During processing, the queue manager maintains secure transaction queuing, preserves transaction state during source selection, implements authentication protocols, and ensures parameter preservation.

At operation 310, initial rule evaluation is performed using sequential analysis. At operation 315, a merchant category is identified. Applicable category-specific rules are determined, and threshold conditions are evaluated. At operation 320, a default source is validated. Pre-configured rules for the merchant category are checked, availability of the default funding source is validated, and transaction parameters are validated.

At decision 325 a processing path is selected by determining if the default funding source is optimal. If it is determined that the default source is optimal at decision 325, the default path is followed, and the transaction is processed using default funding source while maintaining transaction integrity. At operation 335, a confirmation output is provided as visual/haptic signal to a customer device. At operation 340, a digital wallet is updated.

If it is determined that the default funding source is not optimal at decision 325 given identified alternative options identified, the transaction is processed using an alternate path and the transaction state is maintained at operation 345. At operation 350, push notification is triggered with alternative options to present to the customer. In an example, the notification can present alternative funding options, display comparative benefits, and provide interactive selection interface. At operation 355, transaction parameters are preserved. At operation 360, a secure source selection is received. In an example, the customer receives the notification, reviews alternative options, and makes selection through an authenticated secure interface. The source selection may be an alternative source or may be the default source depending on the selection made by the customer. Processing then continues at operation 335 as described above using the selected source and the preserved transaction state.

If processing fails, the original transaction parameters are preserved (e.g., at operation 355) to enable secure transaction recovery and preserve funding source availability using protected state transitions. During recovery secure queue management is used to maintain state preservation (e.g., at operation 345), enable authenticated recovery, and preserve transaction integrity.

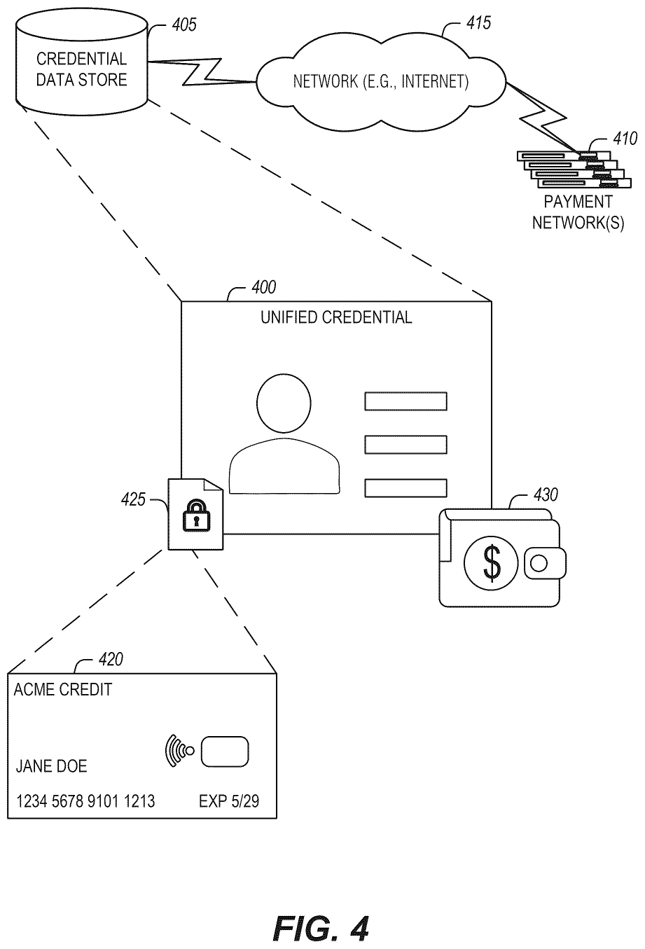

FIG. 4 is a block diagram of an example of a unified credential 400 for flexible credential enabled push notifications, according to an embodiment. The unified credential 400 may provide features as described in FIGS. 1-3.

The unified credential 400 is stored in a credential data store 405 that may be accessed by payment network(s) 410 via a network 415 (e.g., the internet, a local area network, a wide area network, a wireless networks, a shared bus, etc.). The unified credential 400 is a secured (e.g., encrypted, etc.) electronic record that is unique to a user (e.g., the customer 170 as described in FIG. 1, etc.) that may include an association to physical payment facilities 420 (e.g., a credit card, debit card, gift card, checking account, etc.) in an encrypted record 425 of the unified credential 400. The unified credential 400 may include or may be associated with one or multiple digital wallets 430 that may include virtual card numbers, cryptographic currency, and the like.

When the user initiates a transaction with the payment network(s) 410 using the physical payment facility 420 or an element of the digital wallet 430, a unified credential manager (e.g., the system 105 as described in FIG. 1, etc.) is initiated to process rules (e.g., by the rules engine 110 as described in FIG. 1, etc.) to determine if the user should be sent a notification with alternative payment sources. The unified credential 400 can be configured by the user to include a variety of rules as previously described. Default rules may be included that may be executed if the user has not specifically specified an applicable payment source for a transaction. The rules may be updated as additional sources are added and as transaction history of the user changes. Thus, the unified credential 400 enables dual path transaction processing while a transaction is in process whether the initial payment source selected by the user is physical or virtual.

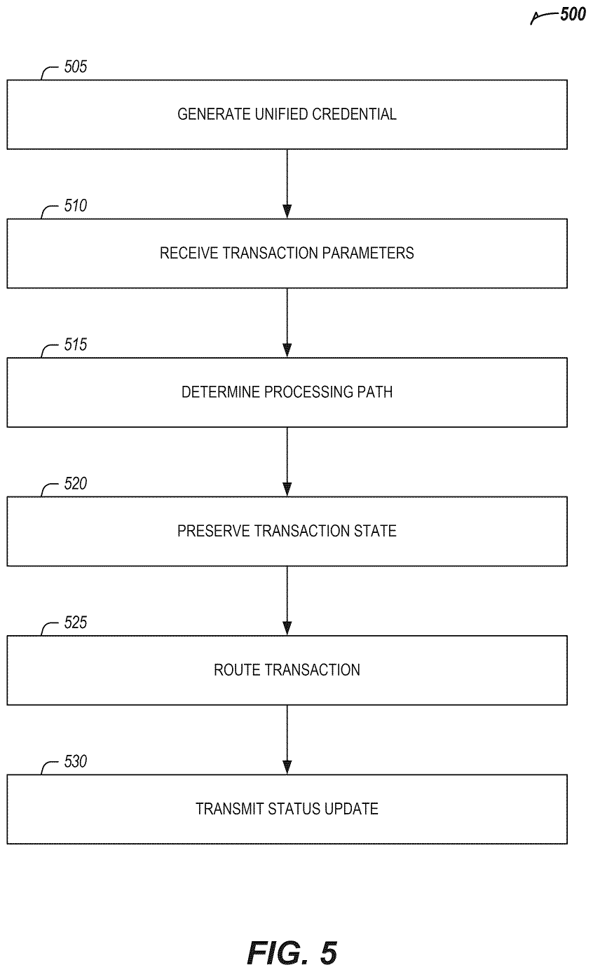

FIG. 5 illustrates an example of a method for flexible credential enabled push notifications, according to an embodiment. The method 500 may provide features as described in FIGS. 1-4.

Multiple funding sources are linked (e.g., by the digital wallet 103 as described in FIG. 1, etc.) to a single unified payment credential (e.g., the unified credential 400 as described in FIG. 4, etc.) using authentication protocols (e.g., at operation 505). Transaction parameters are received (e.g., by the transaction processor 120 as described in FIG. 1, etc.) for a transaction through an encrypted channel (e.g., as provided by the encryption agent 166 as described in FIG. 1, etc.) (e.g., at operation 510).

An optimal processing path is determined (e.g., by the rules engine 110 as described in FIG. 1, etc.) for the transaction between a default path and an alternative path based on the transaction parameters (e.g., at operation 515). In an example, a merchant category can be analyzed for the transaction through pattern matching and available rewards can be calculated for the transaction across the multiple funding sources. Reward rates can be compared between funding sources and threshold-based routing rules can be applied when determining the optimal processing path. In an example, a secure push notification can be generated that includes an alternate payment source associated with the alternative path. The secure push notification can include an identification of the alternate payment source and a description of benefits of the alternate payment source over a default payment source associated with the default path. A received authenticated user response can be processed, and the transaction state can be preserved during user interaction with the secure push notification. Encrypted status updates can be transmitted to the user device.

Transaction state of the transaction is preserved (e.g., by the state manager 140 as described in FIG. 1, etc.) in a secure queue (e.g., of the queue manager 142 as described in FIG. 1, etc.) without pre-authorization of charges (e.g., at operation 520). In an example, the transaction can be securely queued, and the transaction parameters can be maintained during determination of the optimal processing path. Authenticated state transitions can be executed, and queue operations can be coordinated across the default path and the alternative path.

The transaction is routed (e.g., by the transaction processor 120 as described in FIG. 1, etc.) through the optimal processing path while maintaining encryption of the transaction parameters (e.g., at operation 525). In an example, funding source availability can be verified for the default path and the transaction parameters can be preserved. Integrity of the transaction state can be maintained during modification of the optimal processing path and protected recovery operations can be executed for the transaction.

Status updates are transmitted (e.g., by the push notifier 150 as described in FIG. 1, etc.) across digital interfaces to a user device through a protected communication channel (e.g., at operation 530). In an example, a visual confirmation or a haptic feedback response can be generated for inclusion in a status update. A digital wallet of a user can be updated, and cross-platform synchronization can be maintained for the status updates.

In an example, multi-layer authentication protocols can be executed on the encrypted channel and the transaction state can be preserved during modification of the optimal processing path. Secure source switching can be performed to move a transaction from the default path to the alternative path and encrypted data transmission can be maintained during the secure source switching. In an example, parameter transmission can be secured on the encrypted channel. The parameter transmission can be in authenticated data exchange and state preservation can be performed using the encrypted channel.

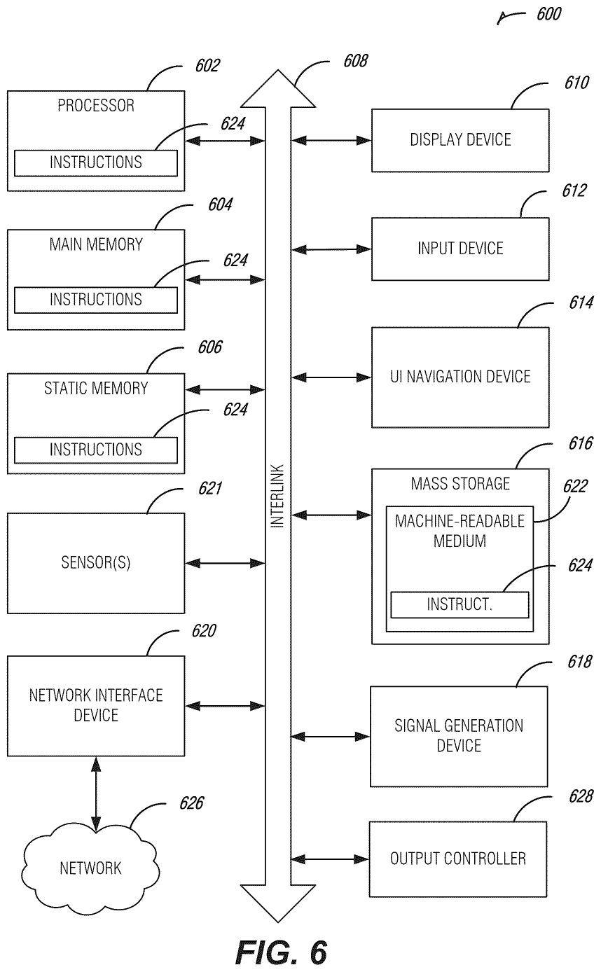

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The machine 600 may further include a display unit 610, an alphanumeric input device 612 (e.g., a keyboard), and a user interface (UI) navigation device 614 (e.g., a mouse). In an example, the display unit 610, input device 612 and UI navigation device 614 may be a touch screen display. The machine 600 may additionally include a storage device (e.g., drive unit) 616, a signal generation device 618 (e.g., a speaker), a network interface device 620, and one or more sensors 621, such as a global positioning system (GPS) sensor, compass, accelerometer, or other sensors. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine-readable medium examples may include solid-state memories, and optical and magnetic media. In an example, machine readable media may exclude transitory propagating signals (e.g., non-transitory machine-readable storage media). Specific examples of non-transitory machine-readable storage media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, LoRa®/LoRaWAN® LPWAN standards, etc.), IEEE 802.15.4 family of standards, peer-to-peer (P2P) networks, 3^{rd} Generation Partnership Project (3GPP) standards for 4G and 5G wireless communication including: 3GPP Long-Term evolution (LTE) family of standards, 3GPP LTE Advanced family of standards, 3GPP LTE Advanced Pro family of standards, 3GPP New Radio (NR) family of standards, among others. In an example, the network interface device 620 may include one or more physical jacks (e.g., Ethernet, coaxial, or phone jacks) or one or more antennas to connect to the communications network 626. In an example, the network interface device 620 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 600, and includes digital or analog communications signals or other intangible medium to facilitate communication of such software.

### ADDITIONAL NOTES & EXAMPLES

Example 1 is a system for secure transaction processing, comprising: at least one processor; and memory comprising instructions that, when executed by the at least one processor, cause the at least one processor to perform operations to: link multiple funding sources to a single unified payment credential using authentication protocols; receive transaction parameters for a transaction through an encrypted channel; select an alternate processing path for the transaction rather than a default path based on the transaction parameters; preserve transaction state of the transaction in a secure queue without pre-authorization of charges; route the transaction through the alternate processing path while maintaining encryption of the transaction parameters; and transmit status updates across digital interfaces to a user device through a protected communication channel.

In Example 2, the subject matter of Example 1 wherein, the instructions to select the alternate processing path include instructions to: analyze merchant category for the transaction through pattern matching; calculate available rewards for the transaction across the multiple funding sources; compare reward rates between funding sources; and apply threshold-based routing rules to select the alternate processing path.

In Example 3, the subject matter of Examples 1-2 wherein, the instructions to preserve the transaction state includes instructions to: securely queue the transaction; maintain the transaction parameters during determination of the alternate processing path; execute authenticated state transitions; and coordinate queue operations across the default path and the alternate processing path.

In Example 4, the subject matter of Examples 1-3 wherein, the instructions to route the transaction includes instructions to: verify funding source availability for the default path; preserve the transaction parameters; maintain integrity of the transaction state during modification of the alternate processing path; and execute protected recovery operations for the transaction.

In Example 5, the subject matter of Examples 1-4 includes, the memory further comprising instructions that, when executed by the at least one processor, cause the at least one processor to perform operations to: generate a secure push notification that includes an alternate payment source associated with the alternate processing path, the secure push notification comprising an identification of the alternate payment source and a description of benefits of the alternate payment source over a default payment source associated with the default path; process a received authenticated user response; preserve the transaction state during user interaction with the secure push notification; and transmit encrypted status updates to the user device.

In Example 6, the subject matter of Examples 1-5 wherein, the instructions to transmit status updates include instructions to: generate a visual confirmation or a haptic feedback response for inclusion in a status update; update a digital wallet of a user; and maintain cross-platform synchronization of the status updates.

In Example 7, the subject matter of Examples 1-6 includes, the memory further comprising instructions that, when executed by the at least one processor, cause the at least one processor to perform operations to: execute multi-layer authentication protocols on the encrypted channel; preserve the transaction state during modification of the alternate processing path; perform secure source switching to move a transaction from the default path to the alternate processing path; and maintain encrypted data transmission during the secure source switching.

In Example 8, the subject matter of Examples 1-7 includes, the memory further comprising instructions that, when executed by the at least one processor, cause the at least one processor to perform operations to: secure parameter transmission on the encrypted channel, wherein the secure parameter transmission is in authenticated data exchange; and perform state preservation using the encrypted channel.

Example 9 is at least one non-transitory machine-readable medium comprising instructions for secure transaction processing that, when executed by at least one processor, cause the at least one processor to perform operations to: link multiple funding sources to a single unified payment credential using authentication protocols; receive transaction parameters for a transaction through an encrypted channel; select an alternate processing path for the transaction rather than a default path based on the transaction parameters; preserve transaction state of the transaction in a secure queue without pre-authorization of charges; route the transaction through the alternate processing path while maintaining encryption of the transaction parameters; and transmit status updates across digital interfaces to a user device through a protected communication channel.

In Example 10, the subject matter of Example 9 wherein, the instructions to select the alternate processing path include instructions to: analyze merchant category for the transaction through pattern matching; calculate available rewards for the transaction across the multiple funding sources; compare reward rates between funding sources; and apply threshold-based routing rules to select the alternate processing path.

In Example 11, the subject matter of Examples 9-10 wherein, the instructions to preserve the transaction state includes instructions to: securely queue the transaction; maintain the transaction parameters during determination of the alternate processing path; execute authenticated state transitions; and coordinate queue operations across the default path and the alternate processing path.

In Example 12, the subject matter of Examples 9-11 wherein, the instructions to route the transaction includes instructions to: verify funding source availability for the default path; preserve the transaction parameters; maintain integrity of the transaction state during modification of the alternate processing path; and execute protected recovery operations for the transaction.

In Example 13, the subject matter of Examples 9-12 includes, instructions that, when executed by the at least one processor, cause the at least one processor to perform operations to: generate a secure push notification that includes an alternate payment source associated with the alternate processing path, the secure push notification comprising an identification of the alternate payment source and a description of benefits of the alternate payment source over a default payment source associated with the default path; process a received authenticated user response; preserve the transaction state during user interaction with the secure push notification; and transmit encrypted status updates to the user device.

In Example 14, the subject matter of Examples 9-13 wherein, the instructions to transmit status updates include instructions to: generate a visual confirmation or a haptic feedback response for inclusion in a status update; update a digital wallet of a user; and maintain cross-platform synchronization of the status updates.

In Example 15, the subject matter of Examples 9-14 includes, instructions that, when executed by the at least one processor, cause the at least one processor to perform operations to: execute multi-layer authentication protocols on the encrypted channel; preserve the transaction state during modification of the alternate processing path; perform secure source switching to move a transaction from the default path to the alternate processing path; and maintain encrypted data transmission during the secure source switching.

In Example 16, the subject matter of Examples 9-15 includes, instructions that, when executed by the at least one processor, cause the at least one processor to perform operations to: secure parameter transmission on the encrypted channel, wherein the secure parameter transmission is in authenticated data exchange; and perform state preservation using the encrypted channel.

Example 17 is a method for secure transaction processing, comprising: linking multiple funding sources to a single unified payment credential using authentication protocols; receiving transaction parameters for a transaction through an encrypted channel; selecting an alternate processing path for the transaction rather than a default path based on the transaction parameters; preserving transaction state of the transaction in a secure queue without pre-authorization of charges; routing the transaction through the alternate processing path while maintaining encryption of the transaction parameters; and transmitting status updates across digital interfaces to a user device through a protected communication channel.

In Example 18, the subject matter of Example 17 wherein, selecting the alternate processing path comprises: analyzing merchant category for the transaction through pattern matching; calculating available rewards for the transaction across the multiple funding sources; comparing reward rates between funding sources; and applying threshold-based routing rules to select the alternate processing path.

In Example 19, the subject matter of Examples 17-18 wherein, preserving the transaction state comprises: securely queuing the transaction; maintaining the transaction parameters during determination of the alternate processing path; executing authenticated state transitions; and coordinating queue operations across the default path and the alternate processing path.

In Example 20, the subject matter of Examples 17-19 wherein, routing the transaction comprises: verifying funding source availability for the default path; preserving the transaction parameters; maintaining integrity of the transaction state during modification of the alternate processing path; and executing protected recovery operations for the transaction.

In Example 21, the subject matter of Examples 17-20 includes, generating a secure push notification that includes an alternate payment source associated with the alternate processing path, the secure push notification comprising an identification of the alternate payment source and a description of benefits of the alternate payment source over a default payment source associated with the default path; processing a received authenticated user response; preserving the transaction state during user interaction with the secure push notification; and transmitting encrypted status updates to the user device.

In Example 22, the subject matter of Examples 17-21 wherein, transmitting status updates comprises: generating a visual confirmation or a haptic feedback response for inclusion in a status update; updating a digital wallet of a user; and maintaining cross-platform synchronization of the status updates.

In Example 23, the subject matter of Examples 17-22 includes, executing multi-layer authentication protocols on the encrypted channel; preserving the transaction state during modification of the alternate processing path; performing secure source switching to move a transaction from the default path to the alternate processing path; and maintaining encrypted data transmission during the secure source switching.

In Example 24, the subject matter of Examples 17-23 includes, securing parameter transmission on the encrypted channel, wherein the parameter transmission is in authenticated data exchange; and performing state preservation using the encrypted channel.

Example 25 is at least one machine-readable medium including instructions that, when executed by processing circuitry, cause the processing circuitry to perform operations to implement of any of Examples 1-24.

Example 26 is an apparatus comprising means to implement of any of Examples 1-24.

Example 27 is a system to implement of any of Examples 1-24.

Example 28 is a method to implement of any of Examples 1-24.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

1. A system for secure transaction processing, comprising:
at least one processor; and
memory comprising instructions that, when executed by the at least one processor, cause the at least one processor to perform operations to:
link multiple funding sources to a single unified payment credential using authentication protocols;
receive transaction parameters for a transaction through an encrypted channel, the transaction specifying a default path to process the transaction;
select an alternate processing path for the transaction rather than the default path based on the transaction parameters;
interrupt the transaction, based on selection of the alternate processing path;
preserve, based on interruption of the transaction, transaction state of the transaction in a secure queue without pre-authorization of charges;
route the transaction through the alternate processing path using the transaction parameters in the transaction state preserved in the secure queue while maintaining encryption of the transaction parameters; and
transmit status updates across digital interfaces to a user device through a protected communication channel.

2. The system of claim 1, wherein the instructions to select the alternate processing path include instructions to:
analyze merchant category for the transaction through pattern matching;
calculate available rewards for the transaction across the multiple funding sources;
compare reward rates between funding sources; and
apply threshold-based routing rules to select the alternate processing path.

3. The system of claim 1, wherein the instructions to preserve the transaction state includes instructions to:
securely queue the transaction;
maintain the transaction parameters during determination of the alternate processing path;
execute authenticated state transitions; and
coordinate queue operations across the default path and the alternate processing path.

4. The system of claim 1, wherein the instructions to route the transaction includes instructions to:
verify funding source availability for the default path;
preserve the transaction parameters;
maintain integrity of the transaction state during modification of the alternate processing path; and
execute protected recovery operations for the transaction.

5. The system of claim 1, the memory further comprising instructions that, when executed by the at least one processor, cause the at least one processor to perform operations to:
generate a secure push notification that includes an alternate payment source associated with the alternate processing path, the secure push notification comprising an identification of the alternate payment source and a description of benefits of the alternate payment source over a default payment source associated with the default path;
process a received authenticated user response;
preserve the transaction state during user interaction with the secure push notification; and
transmit encrypted status updates to the user device.

6. The system of claim 1, wherein the instructions to transmit status updates include instructions to:
generate a visual confirmation or a haptic feedback response for inclusion in a status update;
update a digital wallet of a user; and
maintain cross-platform synchronization of the status updates.

7. The system of claim 1, the memory further comprising instructions that, when executed by the at least one processor, cause the at least one processor to perform operations to:
execute multi-layer authentication protocols on the encrypted channel;
preserve the transaction state during modification of the alternate processing path;
perform secure source switching to move a transaction from the default path to the alternate processing path; and
maintain encrypted data transmission during the secure source switching.

8. The system of claim 1, the memory further comprising instructions that, when executed by the at least one processor, cause the at least one processor to perform operations to:
secure parameter transmission on the encrypted channel, wherein the secure parameter transmission is in authenticated data exchange; and
perform state preservation using the encrypted channel.

9. At least one non-transitory machine-readable medium comprising instructions for secure transaction processing that, when executed by at least one processor, cause the at least one processor to perform operations to:
link multiple funding sources to a single unified payment credential using authentication protocols;
receive transaction parameters for a transaction through an encrypted channel, the transaction specifying a default path to process the transaction;
select an alternate processing path for the transaction rather than the default path based on the transaction parameters;
interrupt the transaction, based on selection of the alternate processing path;
preserve, based on interruption of the transaction, transaction state of the transaction in a secure queue without pre-authorization of charges;
route the transaction through the alternate processing path using the transaction parameters in the transaction state preserved in the secure queue while maintaining encryption of the transaction parameters; and
transmit status updates across digital interfaces to a user device through a protected communication channel.

10. The at least one non-transitory machine-readable medium of claim 9, wherein the instructions to select the alternate processing path include instructions to:
analyze merchant category for the transaction through pattern matching;
calculate available rewards for the transaction across the multiple funding sources;
compare reward rates between funding sources; and
apply threshold-based routing rules to select the alternate processing path.

11. The at least one non-transitory machine-readable medium of claim 9, wherein the instructions to preserve the transaction state includes instructions to:
securely queue the transaction;
maintain the transaction parameters during determination of the alternate processing path;
execute authenticated state transitions; and
coordinate queue operations across the default path and the alternate processing path.

12. The at least one non-transitory machine-readable medium of claim 9, wherein the instructions to route the transaction includes instructions to:
verify funding source availability for the default path;
preserve the transaction parameters;
maintain integrity of the transaction state during modification of the alternate processing path; and
execute protected recovery operations for the transaction.

13. The at least one non-transitory machine-readable medium of claim 9, further comprising instructions that, when executed by the at least one processor, cause the at least one processor to perform operations to:
generate a secure push notification that includes an alternate payment source associated with the alternate processing path, the secure push notification comprising an identification of the alternate payment source and a description of benefits of the alternate payment source over a default payment source associated with the default path;
process a received authenticated user response;
preserve the transaction state during user interaction with the secure push notification; and
transmit encrypted status updates to the user device.

14. The at least one non-transitory machine-readable medium of claim 9, further comprising instructions that, when executed by the at least one processor, cause the at least one processor to perform operations to:
execute multi-layer authentication protocols on the encrypted channel;
preserve the transaction state during modification of the alternate processing path;
perform secure source switching to move a transaction from the default path to the alternate processing path; and
maintain encrypted data transmission during the secure source switching.

15. A method for secure transaction processing, comprising:
linking multiple funding sources to a single unified payment credential using authentication protocols;
receiving transaction parameters for a transaction through an encrypted channel, the transaction specifying a default path to process the transaction;
selecting an alternate processing path for the transaction rather than the default path based on the transaction parameters;
interrupt the transaction, based on selection of the alternate processing path;
preserving, based on interruption of the transaction, transaction state of the transaction in a secure queue without pre-authorization of charges;
routing the transaction through the alternate processing path using the transaction parameters in the transaction state preserved in the secure queue while maintaining encryption of the transaction parameters; and
transmitting status updates across digital interfaces to a user device through a protected communication channel.

16. The method of claim 15, wherein selecting the alternate processing path comprises:
analyzing merchant category for the transaction through pattern matching;
calculating available rewards for the transaction across the multiple funding sources,
comparing reward rates between funding sources; and
applying threshold-based routing rules to select the alternate processing path.

17. The method of claim 15, wherein preserving the transaction state comprises:
securely queuing the transaction;
maintaining the transaction parameters during determination of the alternate processing path;
executing authenticated state transitions; and
coordinating queue operations across the default path and the alternate processing path.

18. The method of claim 15, wherein routing the transaction comprises:
verifying funding source availability for the default path;
preserving the transaction parameters;
maintaining integrity of the transaction state during modification of the alternate processing path; and
executing protected recovery operations for the transaction.

19. The method of claim 15, further comprising:
generating a secure push notification that includes an alternate payment source associated with the alternate processing path, the secure push notification comprising an identification of the alternate payment source and a description of benefits of the alternate payment source over a default payment source associated with the default path;
processing a received authenticated user response;
preserving the transaction state during user interaction with the secure push notification; and
transmitting encrypted status updates to the user device.

20. The method of claim 15, further comprising:
executing multi-layer authentication protocols on the encrypted channel;
preserving the transaction state during modification of the alternate processing path;
performing secure source switching to move a transaction from the default path to the alternate processing path; and
maintaining encrypted data transmission during the secure source switching.
